(19) United States
(12) Patent Application Publication
(10) Pub. No.: US 2002/0005768 A1
(43) Pub. Date: Jan. 17, 2002

(54) Method for attaching a resonator part and a resonator

(75) Inventor: Esa Mikkonen, Oulu (FI)

Correspondence Address: DARBY & DARBY P.C., 805 Third Avenue, New York, NY, 10022, US

(73) Assignee: FILTRONIC LK OY

(21) Appl. No.: 09/902,852

(22) Filed: Jul. 10, 2001

(30) Foreign Application Priority Data
Jul. 17, 2000 (FI) 20001676

(51) Int. Cl. H01P 1/201

(52) U.S. Cl. 333/203; 333/222

(57) ABSTRACT

The invention relates to a method for attaching an additional object to an object made by the process of extruding, especially a resonator body, and to the structure resulting from the application of the method. A recess is made in the pushing part (ES) of an extrusion machine, which recess is shaped like a portion of the surface of the additional object. The additional object (320), such as a portion of the inner conductor of a resonator, is inserted prior to extrusion in the said recess so that the said portion of the surface of the additional object rests tightly against the surface of the recess and the rest of the surface of the additional object remains free. In the extrusion stage, the pushing part with the additional object is pressed (F) against a bloom of a resonator body whereby the material (31c) of the bloom is pressed tight against the free surface of the additional object. When the pushing part is retracted the additional object remains attached to the body element thus formed. According to the invention, in conjunction with the manufacturing of the body element of the structure being manufactured, parts may be added to the body element without separate manufacturing steps, and the resulting bond is strong and uniform. Furthermore, in a filter manufactured according to the invention the inner conductors of the different resonators may be manufactured in different lengths.

The invention relates to a method for attaching a part to an object made by the process of extruding, especially a resonator body. The invention further relates to the structure resulting from the application of the method.

Air-insulated coaxial resonators are popular e.g. in radio-frequency filters at base stations of mobile communication networks because of their relatively good electrical characteristics and good manufacturability. A coaxial resonator is most often a quarter-wave resonator where one end of the resonator is short-circuited, i.e. the inner conductor and outer conductor of the resonator are in galvanic contact, and the other end is open. When manufacturing a filter comprising a plurality of resonators, it has to be taken into account that the desired frequency response of the filter may require inner conductors of different lengths. In addition, it may be necessary to compensate for the change in the resonance frequency caused by thermal expansion in the resonator structure.

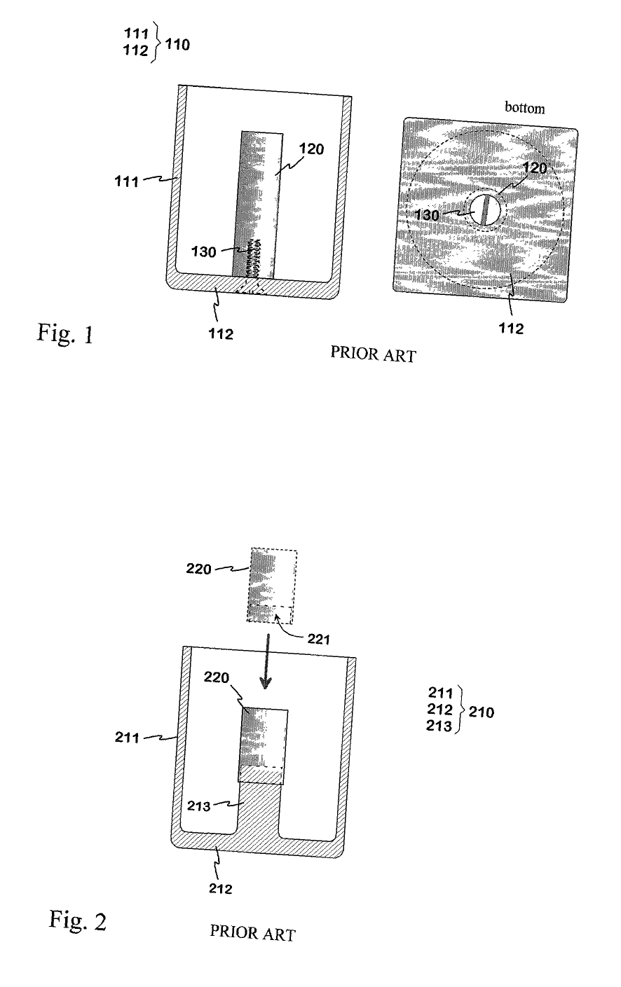

There are several known methods for manufacturing coaxial resonators functioning as filter elements. FIG. 1 depicts a known structure viewed from the side and from the bottom. Shown in the figure is the resonator's outer conductor 111, inner conductor 120, and the bottom 112. The outer conductor and the bottom are shown in longitudinal section. They constitute a single body 110 having a quadrangular cross section and a cylinder-shaped cavity. The body 110 is made by the process of milling or extruding, for example. The inner conductor is in the said cavity, attached to the bottom 112 of the resonator so that the bottom provides the short circuit between the inner and outer conductor. In this example, the attachment of the inner conductor is realized using a screw 130 extending through the bottom to the inner conductor. The inner conductor may be of the same or different material than the body 110. In the latter case, the temperature compensation in the resonator may be realized through the choice of materials. FIG. 1 shows only one resonator in a simplified form. A whole filter may have several cavities in one and the same body with electromagnetic couplings between the cavities. On top of the whole structure there is a conductive cover.

A disadvantage of the structure depicted in FIG. 1 is that the attachment of the inner conductor takes several manufacturing stages and the attachment strength does not meet the strictest requirements. Moreover, the interfaces between the different metals in the structure may cause harmful intermodulation products when using the device.

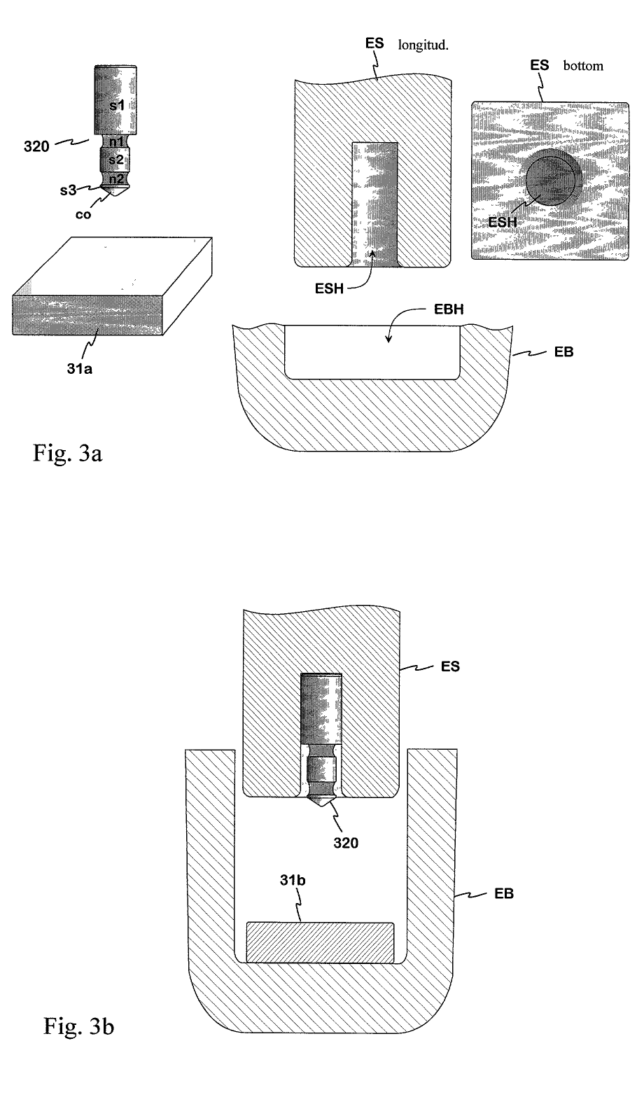

FIG. 2 shows a longitudinal section of another known structure. The figure shows the resonator's outer conductor 211 and bottom 212. The resonator's inner conductor has now two parts: A lower part 213 nearer the bottom of the resonator and an upper part 220 forming a continuation of the lower part. In this example, the lower part 213 of the inner conductor, bottom 212 and the outer conductor 211 constitute a single body 210. At the bottom end of the upper part of the inner conductor there is a cylindrical hollow 221 the diameter of which equals that of the lower part of the inner conductor. Thus the upper part 220 may be pushed onto the lower part 213 as a cap. The purpose of the upper part of the inner conductor is to provide for the temperature compensation in the resonator. A disadvantage of the structure is that the attachment of the inner conductor requires a separate manufacturing stage. Moreover, in this case, too, the risk of harmful intermodulation is apparent at the attachment interface.

An object of the invention is to reduce the above-mentioned disadvantages associated with the prior art. The method according to the invention is characterized by that which is specified in the independent claim 1. The structure according to the invention is characterized by that which is specified in the independent claims 2 and 9. Some preferred embodiments of the invention are specified in the other claims.

The basic idea of the invention is as follows: a resonator body is manufactured by means of extrusion. In the pushing part of the extrusion machine a recess is made which is shaped like a portion of the surface of the additional object to be attached to the body. The additional object, such as a portion of an inner conductor, is inserted prior to the extrusion in the said recess so that the said portion of the surface of the additional object is positioned tightly against the surface of the recess and the rest of the surface of the additional object remains free. In the extrusion stage, the pushing part with the additional object is pressed against the bloom of body whereby the material of the bloom is pressed tight against the free surface of the additional object. When the pushing part is retracted the additional object remains attached to the body thus formed.

An advantage of the invention is that in conjunction with the manufacturing of the body part of the structure being manufactured, parts may be added to the body without separate manufacturing steps. This means savings in the manufacturing costs. Another advantage of the invention is that the bond according to the invention between the additional part and body part is stronger and more uniform than similar prior-art bonds. This means higher reliability of the structure and less intermodulation at the attachment interface. A further advantage of the invention is that in a filter manufactured according to the invention the inner conductors of the different resonators may be manufactured in different lengths, if necessary, by using recesses of different lengths in the pushing parts of the extrusion machine. The additional parts to be attached to the inner conductors may then be identical, which is advantageous from the standpoint of manufacture.

The invention is described in more detail in the following. Reference is made to the accompanying drawings in which

FIG. 1 shows an example of a resonator according to the prior art,

FIG. 2 shows another example of a resonator according to the prior art,

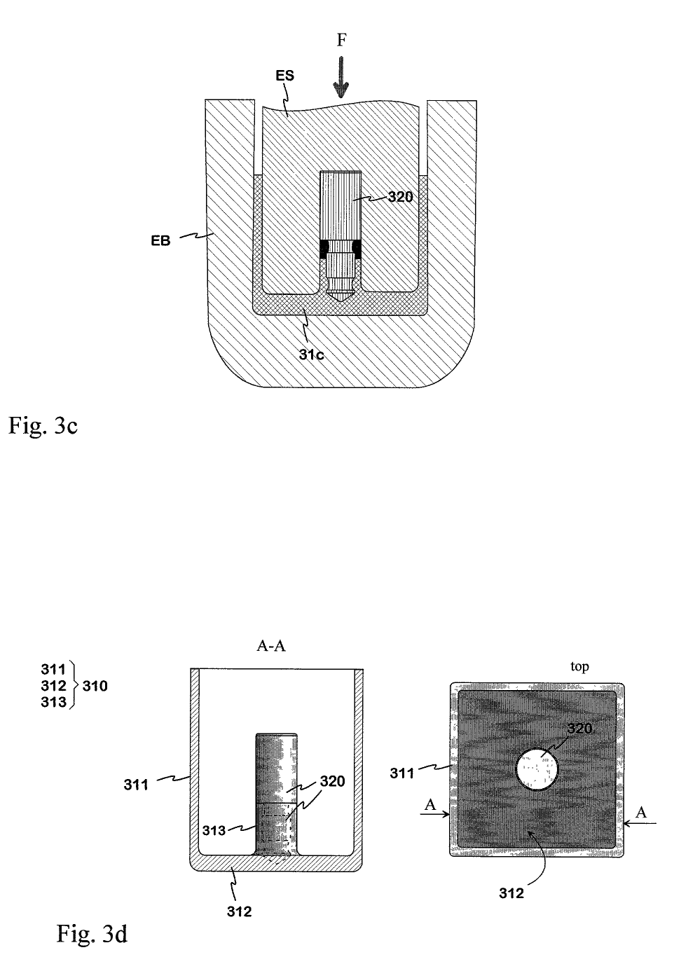

FIGS. 3a-d depict the method according to the invention and an example of a resonator manufactured according to the invention,

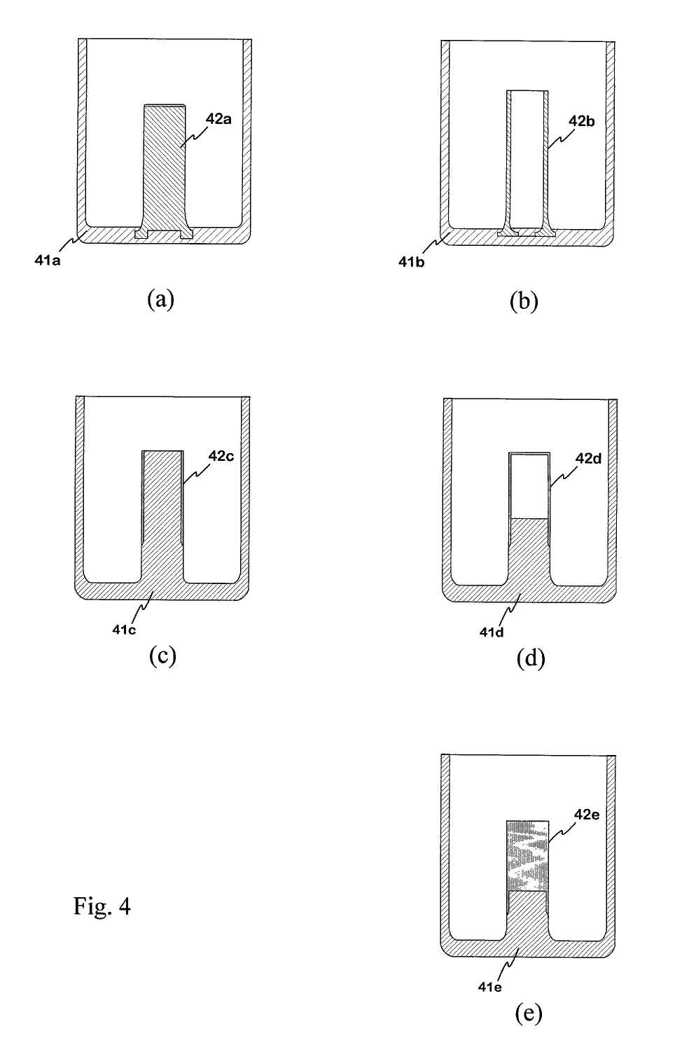

FIG. 4 shows more examples of a resonator manufactured according to the invention, and

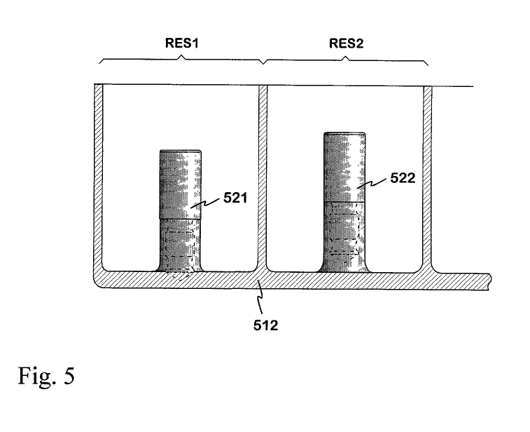

FIG. 5 shows an example of a filter structure according to the invention.

FIGS. 1 and 2 were already discussed in conjunction with the description of the prior art.

FIG. 3 depicts the initial situation of the manufacturing method according to the invention. Shown in the figure is a bloom 31a of a resonator body, an additional object 320 to be attached to the body structure, an extrusion base EB serving as a mold, and a pushing part ES of an extrusion machine. The additional object 320 is drawn vertical. In this example it comprises on one and the same axis a cylindrical upper part s1 and a lower part having a first neck section n1, a second cylinder section s1, a second neck section n2, a third cylinder section s3 and a cone section co. The second and third cylinder sections are rounded at the comers. The diameter of the upper part is greater than the diameter of the lower part at any point. The shape of the bloom 31a is a rectangular prism. The extrusion base EB is drawn in FIG. 3a in longitudinal section and the upper part cut out. It has in the center a recess EBH that corresponds to the outer dimensions of the object to be manufactured. The pushing part ES of the extrusion machine is depicted both in longitudinal section and viewed from below. The dimensions of the cross section of the pushing part correspond to the inner dimensions of the cross section of the body of the object to be manufactured. The pushing part has a recess ESH according to the invention. The cylindrical recess ESH starts from the lower surface of the pushing part and its diameter is substantially the same as the diameter of the upper part of the additional object.

In FIG. 3b the bloom 31b is placed on the extrusion base EB. An additional object 320 is placed in the recess of the pushing part ES of the extrusion machine. The diameters of the upper part of the additional object and the recess of the pushing part correspond to each other so that the additional object, when its upper part is suitably lubricated, fits tightly into the recess. In this example the length of the recess of the pushing part is such that the conic lowest section of the additional object 320 remains below the lower surface of the pushing part. An empty space is left around the lower part of the additional object.

FIG. 3c depicts the extrusion stage. The pushing part ES is pressed at a force F downward against the bloom. The pressure forces the material 31c of the bloom to spread into free spaces, which include the relatively narrow space between the walls of the extrusion base EB and pushing part ES and the space around the lower part of the additional object in the recess of the pushing part. In the situation of FIG. 3c the latter space has been a bit over half filled. As the downward movement of the pushing part ES ceases, the body material 31c has totally filled the space around the lower part of the additional object and risen between the walls into the designated height. After that, the pushing part ES is pulled back up. The additional object 320 remains attached to the body part thus formed. The bond between the body part and the additional object achieved in the manner described is strong because the metallic extrusion material tightly fills up the space around the lower part of the additional object. The design of the lower part of the additional object according to this example adds to the strength of the bond: The said two neck sections n1 and n2 having cylinder surfaces constricted at the middle provide excellent attachment points.

FIG. 3d shows a longitudinal section and a top view of a resonator structure removed from the extrusion base. The cross section of the outer conductor 311 of the resonator structure is quadrangular in accordance with the design of the extrusion base and pushing part of the extrusion machine. A homogeneous body part 310 comprises the outer conductor 311, bottom 312 and conductive material 313 around the lower part of the additional object 320. The inner conductor of the resonator comprises the said conductive material 313 and additional object 320 excluding the cone section. The cone section remains within the bottom 312. FIG. 3d shows a single resonator (without a cover) produced at this stage. Using the method described it is possible to manufacture at one time a whole filter body with attached objects by means of an extrusion machine with several pushing parts. The recesses in the pushing parts may have different lengths. Using a recess in which the additional object can be inserted in its totality, the additional object in the finished product will be positioned higher from the bottom of the structure than in FIG. 3d. Thus in filters with several resonators the resonators may have inner conductors of different lengths, if necessary, even when the additional objects are identical. FIG. 5 shows an example of such a structure, where in accordance with the above the inner conductor of a resonator RES1 in a filter is shorter than the inner conductor of another resonator RES2.

FIG. 4 shows in longitudinal sections further examples of resonators manufactured according to the invention. In the sub-figure (a) the additional object 42a is a cylindrical object the lower part of which spreads into a flange-like base. In the extrusion stage the additional object fills the recess in the pushing part of the extrusion machine in its entirety. The base part of the additional object remains outside the recess so that it lies inside the bottom of the resonator body 41a after the extrusion has been completed. The inner conductor of the resonator comprises the additional object 42a excluding the part that remains inside the resonator bottom.

In sub-figure 4(b) the additional object is an object shaped like a cylinder mantle, in the lower part of which the cylinder walls spread into a flange-like base. In the extrusion stage the additional object 42b fills the recess in the pushing part of the extrusion machine in its entirety but the recess itself is now shaped like a cylinder mantle. The base part of the additional object remains outside the recess so that it lies inside the bottom of the resonator body 41b after the extrusion has been completed. The inner conductor of the resonator comprises the additional object 42b excluding the part that remains inside the resonator bottom.

In sub-figure 4(c) the additional object 42c is a thin-walled object shaped like a cylinder mantle. In the extrusion stage the additional object is in the pushing part's recess shaped like an open cylinder so that the additional object does not reach the edge of the recess. Extrusion thus produces in the body part 41c a cylindrical inner conductor around the upper end of which the additional object is attached.

In sub-figure 4(d) the additional object 42d is a relatively thin-walled object comprising a cylinder mantle and one end. In the extrusion stage the additional object is positioned in the pushing part's recess, which is shaped like an open cylinder, so that its closed end is in the bottom of the recess and the open end does not reach the edge of the recess. The recess in the pushing part, additional object and the bloom of the resonator body are dimensioned such that in the extrusion, the material of the bloom extends inside the additional object but fills it only partly. Thus is produced a resonator inner conductor comprising a cylindrical part in the body 41d and additional object 42d around its upper end. In accordance with the above, the body extends only partly inside the additional object, so the upper end of the inner conductor is hollow.

In sub-figure 4(e) the additional object 42e is a cylindrical object having at one end a cylindrical recess the diameter of which is nearly the same as that of the additional object. In the extrusion stage the additional object is positioned in the recess of the pushing part of the extrusion machine, which recess is shaped like an open cylinder, so that its solid end is in the bottom of the recess of the pushing part and the open end does not reach the edge of the recess. In the extrusion, the material of the bloom fills entirely the recess of the open end of the additional object. Thus is produced a resonator inner conductor the lower part of which comprises a cylindrical part in the body 41e and the upper part of which comprises the additional object 42e. In accordance with the above, the additional object is compressed around the upper end of the lower part of the inner conductor.

In all versions of the resonator or filter according to the invention, the additional objects attached to the body are primarily used for temperature compensation in the resonator. The body part is advantageously aluminum and the additional objects may be copper or steel, for example.

Above it was described the method according to the invention and some structures according to it. The invention is not limited solely to those. The shapes of the objects belonging to the structure may understandably vary a great deal. For example, the inner conductors of the resonators may be rectangular instead of circular. The inventional idea may be applied in various ways within the scope defined by the independent claims.

1. A method for attaching an additional object to a body element, which additional object has a first and a second surface, and which body element is manufactured by the process of extrusion, whereby said attaching takes place in conjunction with said extrusion, the method comprising steps;
the additional object is placed in a recess made in the pushing part of an extrusion machine so that the first surface of the additional object rests against the surface of the said recess and the second surface is surrounded by air,
the said pushing part is pressed against the bloom of the body element in order to form the body element and to press the material of the body element against the second surface of the additional object, and
the pushing part is pulled back from the resulting body element and from the additional object attached thereto.

2. A coaxial resonator structure comprising a body element formed by the process of extrusion and an homogeneous additional object attached thereto, which additional object has a first and a second surface and at least partly constitutes the inner conductor of the resonator, whereby the attachment of the additional object to the body element is based on compressing the body element against the said second surface, and the first surface of the additional object borders the resonator cavity.

3. A structure according to claim 2, the said homogeneous additional object comprising on one and the same axis a first cylinder part, at least a first neck part and at least a second cylinder part, whereby the said first surface consists of the cylindrical surface and the surface of one end of the first cylinder part and the said second surface consists of the rest of the surface of the additional object.

4. A structure according to claim 2, whereby the said homogeneous additional object is a cylindrical object one end of which is flange-like and larger in diameter than the rest of the additional object, the said first surface substantially consisting of the surface of that part of the additional object which has the same diameter throughout and the said second surface substantially consisting of the surface of the said flange-like portion.

5. A structure according to claim 2, whereby the said homogeneous additional object is an object shaped like a cylindrical mantle one end of which is a flange-like ring and larger in diameter than the rest of the additional object, the said first surface substantially consisting of the outer and inner surfaces of that part of the additional object which has the same diameter throughout and the said second surface substantially consisting of the surface of the said flange-like portion.

6. A structure according to claim 2, whereby the said homogeneous additional object is an object shaped like a cylindrical mantle, the said first surface consisting of the outer surface of the additional object and the said second surface consisting of the inner surface of the additional object.

7. A structure according to claim 2, whereby the said homogeneous additional object is a hollow cylindrical object one end of which is open, the said first surface consisting of the outer surface of the additional object and the said second surface consisting of a part of the inner surface of the additional object.

8. A structure according to claim 2, whereby the said homogeneous additional object is a cylindrical object one end of which is solid and the other end has a recess in it, the said first surface consisting of the outer cylindrical surface of the additional object and the surface of the solid end, and the said second surface consisting of the surface of the open end and the surface of the recess in the open end of the additional object.

9. A filter structure having at least a first and a second coaxial resonator, and comprising a body element manufactured by the process of extrusion and, attached to the body element, at least a first additional object in the first resonator and a second additional object in the second resonator, which additional objects constitute at least partly the inner conductors of the said resonators, and which additional objects each have a first and a second surface, whereby the attachments of the additional objects to the body element are based on compressing the body element against the said second surfaces, and the first surface of each additional object borders the cavity of a resonator.

10. A filter structure according to claim 9, whereby the said first and second additional object are identical, and the second additional object is positioned farther away from the bottom of the filter structure than the first additional object.
